(19) United States
(12) Patent Application Publication
(10) Pub. No.: US 2007/0145943 A1
(43) Pub. Date: Jun. 28, 2007

(54) Charging apparatus and charging apparatus for self-propelled apparatus

(75) Inventor: Kazuya Sudo, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/645,176

(22) Filed: Dec. 26, 2006

(30) Foreign Application Priority Data
Dec. 27, 2005 (JP) 2005-375558

(51) Int. Cl. H02J 7/00

(52) U.S. Cl. 320/104

(57) ABSTRACT

Disclosed is a charging apparatus which supplies electricity to a device, including: a contact terminal which comes into contact with a terminal provided on the device to supply electricity, when the device is detachably attached; a moving member on which the contact terminal is mounted and which is supported movably in a front-rear direction; a biasing member to bias the moving member forward; and a current-carrying member to supply electricity to the device through the contact terminal, wherein one contact terminal is constantly in electrical contact with the current-carrying member, the other contact terminal separates from the current-carrying member when the moving member moves forward by the biasing member, and at least one of connecting parts of the other contact terminal is electrically connected to the current-carrying member when the moving member moves rearward by an engaging motion of the device.

### BACKGROUND OF THE INVENTION

1. Field of the Invention

The present invention relates to a charging apparatus, and a charging apparatus for a self-propelled apparatus.

2. Description of Related Art

Conventionally, there is a known charging apparatus capable of supplying electricity for charge to an apparatus to be charged which is engaged thereto. More specifically, the charging apparatus includes a contact terminal, and when the contact terminal comes into contact with a terminal of the apparatus to be charged, electricity is supplied to the apparatus to be charged.

In such a charging apparatus, the contact terminal is exposed while the apparatus to be charged is not engaged with the charging apparatus. Therefore, if electricity can be supplied also when the apparatus to be charged is not engaged, there is a problem of a risk that the contact terminal is short out.

To overcome this problem, there is proposed a charging apparatus in which (e.g., JP 2003-348759A) the charging apparatus is provided with a protecting member which protects the contact terminal, and when the apparatus to be charged is engaged, the protecting member moves to a position where the contact terminal is exposed by utilizing a pressing force from the apparatus to be charged, and when the apparatus to be charged is separated, the protecting member returns to a position where the contact terminal is protected by utilizing elasticity of an elastic member. If the charging apparatus is provided with the protecting member, however, the number of constituent parts is increased, and labor and cost required for producing the charging apparatus are increased.

To eliminate the need of providing the protecting member or the like to protect the contact terminal, there is proposed a charging apparatus capable of supplying electricity only when the apparatus to be charged is engaged. More specifically, a charging apparatus for a cordless transmitter/receiver includes a contact terminal including an outer terminal strip which can elastically be deformed and an inner terminal strip connected to a charging circuit, when the cordless transmitter/receiver is engaged, the outer terminal strip can elastically deform by utilizing the pressing force from the cordless transmitter/receiver so as to bring the outer terminal strip into abutment against the inner terminal strip, and when the cordless transmitter/receiver is separated, the outer terminal strip separates from the inner terminal strip by utilizing the elasticity of the outer terminal strip (see JP 11-168836A, for example).

In recent years, there is known a moving robot such as a self-propelled cleaner which runs based on a predetermined running pattern to perform a given function or task. The moving robot has a storage battery for storing driving electricity of the moving robot, and the moving robot can autonomously run to a predetermined charging apparatus to put the storage battery on charge. In the charging apparatus for such a moving robot, if electricity can be supplied while the moving robot is not engaged, there is a risk to cause a short circuit. It is difficult to employ the mechanism as disclosed in JP 11-168836A to the charging apparatus of the moving robot. because the mechanism of JP 11-168836A is for the charging apparatus for the cordless transmitter/receiver and pressing force from the cordless transmitter/receiver is received by a “point”, electricity cannot be supplied until the cordless transmitter/receiver is engaged at a correct position and at a correct angle. Whereas, since the moving robot is autonomously engaged with the charging apparatus, a small error is prone to be caused in the engaging position and the engaging angle as compared with the cordless transmitter/receiver. Thus, it is difficult to employ the mechanism of JP 11-168836A for the charging apparatus of the moving robot.

### SUMMARY OF THE INVENTION

It is one of objects of the present invention to provide a charging apparatus and a charging apparatus for a self-propelled apparatus which have a simple mechanism and capable of supplying electricity only when an apparatus to be charged is reliably engaged.

In order to attain the object, according to a first aspect of the invention, a charging apparatus for a self-propelled apparatus which supplies electricity for electric charging to the self-propelled apparatus performing autonomous run for the electric charging, the charging apparatus comprises: a convex contact terminal which comes into contact with a concave contact terminal provided to the self-propelled apparatus to supply electricity to the self-propelled apparatus, when the self-propelled apparatus is detachably attached; a moving member on which the convex contact terminal is mounted and which is supported by a main body of the charging apparatus movably in a front-rear direction and rotatably in a vertical direction; a biasing member to bias the moving member forward; and a current-carrying member to supply electricity to the self-propelled apparatus through the convex contact terminal, wherein the convex contact terminal is long in a lateral direction of the main body of the charging apparatus, a minus convex contact terminal of the convex contact terminal is constantly in electrical contact with the current-carrying member, a plus convex contact terminal separates from the current-carrying member when the moving member moves forward by the biasing member, and at least one of a left end and a right end of the plus convex contact terminal is electrically connected to the current-carrying member when the moving member moves rearward by a force from the self-propelled apparatus in association with an engaging motion of the self-propelled apparatus with the convex contact terminal, and

the current-carrying member includes two electrodes which are electrically connected to the left end and the right end of the plus convex contact terminal respectively.

By doing so, the convex contact terminal is long in the lateral direction, the moving member moves rearward by the force from the self-propelled apparatus in association with the engaging motion of the self-propelled apparatus. With this, when at least one of the left end and right end of the rear end of the plus electrode terminal of the convex contact terminal comes into contact with the current-carrying member, electricity is supplied to the self-propelled apparatus by the current-carrying member through the convex contact terminal. That is, a force from the self-propelled apparatus can be received with a “line”. Even if the “line” can not be connected to the current-carrying member in the whole part thereof due to an error in the lateral direction of fine errors in the engaging position and the engaging angle of the self-propelled apparatus, if at least one end (at least one end of the left end and right end of the plus electrode terminal) of the “line” is connected to the current-carrying member, electricity can be supplied to the self-propelled apparatus. Therefore, with a simple structure, only when the self-propelled apparatus is engaged, electricity can be supplied reliably and efficiently.

The moving member is supported by the main body of the charging apparatus rotatably in the vertical direction. Therefore, with respect to the fine errors in the engaging position and engaging angle of the self-propelled apparatus, it is possible to accept not only an error in the lateral direction but also an error in the vertical direction. As a result, electricity can be supplied more reliably and more efficiently only when the self-propelled apparatus is engaged.

According to a second aspect of the invention, a charging apparatus which supplies electricity to an apparatus to be charged, comprises: a contact terminal which comes into contact with a terminal provided on the apparatus to be charged to supply electricity to the apparatus to be charged, when the apparatus to be charged is detachably attached; a moving member on which the contact terminal is mounted and which is supported by a main body of the charging apparatus movably in a front-rear direction; a biasing member to bias the moving member forward; and a current-carrying member to supply electricity to the apparatus to be charged through the contact terminal, wherein one of a minus terminal and a plus terminal of the contact terminal is constantly in electrical contact with the current-carrying member, the other of the contact terminal separates from the current-carrying member when the moving member moves forward by the biasing member, and at least one of a plurality of connecting parts of the other of the contact terminal is electrically connected to the current-carrying member when the moving member moves rearward by a force from the apparatus to be charged in association with an engaging motion of the apparatus to be charged with the contact terminal.

By doing so, when the moving member moves rearward by the force from the apparatus to be charged in association with the engaging motion of the apparatus to be charged, at least one of the plurality of connection parts of the other contact terminal of the plus and minus contact terminals is connected to the current-carrying member. Accordingly, electricity can be supplied to the apparatus to be charged by the current-carrying member through the contact terminal. That is, even if some of the plurality of connection parts can not be connected due to a small error in the engaging position and engaging angle of the apparatus to be charged, if at least one of the connection part of the plurality of connection parts is connected to the current-carrying member, electricity can be supplied to the apparatus to be charged. Therefore, with a simple structure, only when the apparatus to be charged is engaged, electricity can be supplied reliably and efficiently.

In the second aspect, preferably, the contact terminal is long in a lateral direction of the main body of the charging apparatus, and the current-carrying member includes two electrodes which are electrically connected to the left end and the right end of the other of the contact terminal respectively.

By doing so, the contact terminal is long in the lateral direction. If at least one of the left end and right end of the other contact terminal of the plus and minus contact terminals is connected to the electrode of the current-carrying member, electricity can be supplied to the apparatus to be charged by the current-carrying member through the contact terminal. That is, a force from the apparatus to be charged can be received with a “line”. Even if the “line” can not be connected to the current-carrying member in the whole part thereof due to an error in the lateral direction of fine errors in the engaging position and engaging angle of the apparatus to be charged, if at least one end (at least one end of the left end and right end of the other contact terminal) of the “line” is connected to the current-carrying member, electricity can be supplied to the apparatus to be charged. Therefore, with a simple structure, only when the apparatus to be charged is engaged, electricity can be supplied reliably and efficiently.

In the second aspect, preferably, the moving member is supported by the main body of the charging apparatus rotatably in a vertical direction.

By doing so, since the moving member is supported by the main body of the charging apparatus rotatably in the vertical direction. Therefore, with respect to the errors in the engaging position and engaging angle of the apparatus to be charged, it is possible further to accept an error in the vertical direction, and electricity can be supplied more reliably and more efficiently only when the apparatus to be charged is engaged.

In the second aspect, the apparatus to be charged is preferably a self-propelled cleaner.

### BRIEF DESCRIPTION OF THE DRAWINGS

The present invention will become more fully understood from the detailed description given hereinbelow and the appended drawings which given by way of illustration only, and thus are not intended as a definition of the limits of the present invention, and wherein;

FIG. 1 is a perspective view of a state in which a cover covers a convex contact terminal in a charging apparatus for a self-propelled cleaner according to the present embodiment as viewed from the front but slightly left side;

FIG. 2 is a perspective view of a state in which the cover exposes the convex contact terminal and the convex contact terminal is downwardly turned in the charging apparatus for a self-propelled cleaner according to the embodiment of the invention as viewed from the front but slightly left side;

FIG. 3 is a perspective view of an internal structure of a state in which the cover covers the convex contact terminal in the charging apparatus for a self-propelled cleaner according to the embodiment of the invention as viewed from the back but slightly left side;

FIG. 4 is a perspective view of the internal structure of a state in which the cover exposes the convex contact terminal in the charging apparatus for a self-propelled cleaner according to the embodiment of the invention as viewed from the back but slightly left side.

FIG. 5 is a left side-view of a state in which the cover covers the convex contact terminal in the charging apparatus for a self-propelled cleaner according to the embodiment of the invention;

FIG. 6 is a left side view of a state in which the cover exposes the convex contact terminal and the convex contact terminal is moved (biased) forward in the charging apparatus for a self-propelled cleaner according to the embodiment of the invention;

FIG. 7 is a left side view of a state in which the cover exposes the convex contact terminal and the convex contact terminal is moved rearward in the charging apparatus for a self-propelled cleaner according to the embodiment of the invention;

FIG. 8 is a left side view of a state in which the cover exposes the convex contact terminal and the convex contact terminal is turned downward in the charging apparatus for a self-propelled cleaner according to the embodiment of the invention;

FIG. 9 is a left side view of a state in which the cover exposes the convex contact terminal and the convex contact terminal is turned upward in the charging apparatus for a self-propelled cleaner according to the embodiment of the invention;

FIG. 10 is a rear view of the convex contact terminal and a terminal moving and turning mechanism provided in the charging apparatus for a self-propelled cleaner according to the embodiment of the invention;

FIG. 11 is a left side view showing a state in which the self-propelled cleaner is disengaged from the charging apparatus for a self-propelled cleaner according to the embodiment of the invention;

FIG. 12 is a left side view showing a state in which the self-propelled cleaner is engaged with or disengaged from the charging apparatus for a self-propelled cleaner according to the embodiment of the invention; and

FIG. 13 is a left side view showing a state in which the self-propelled cleaner is engaged with the charging apparatus for a self-propelled cleaner according to the embodiment of the invention.

### DETAILED DESCRIPTION OF PREFERRED EMBODIMENTS

The best mode of an embodiment of a charging apparatus for a self-propelled cleaner (hereinafter, referred to as “charging apparatus”) according to the present invention will be explained in detail with reference to the drawings. The scope of the invention is not limited to the illustrated examples. Although the following embodiment describes a charging apparatus for a self-propelled cleaner, the apparatus to be charged by the charging apparatus is not limited to the self-propelled cleaner.

According to the charging apparatus 1, a self-propelled cleaner 8 as a apparatus to be charged runs autonomously to put, on charge, a storage battery (not shown) which accumulates driving electricity, and electricity is supplied for the charging.

<Composition of Charging Apparatus>

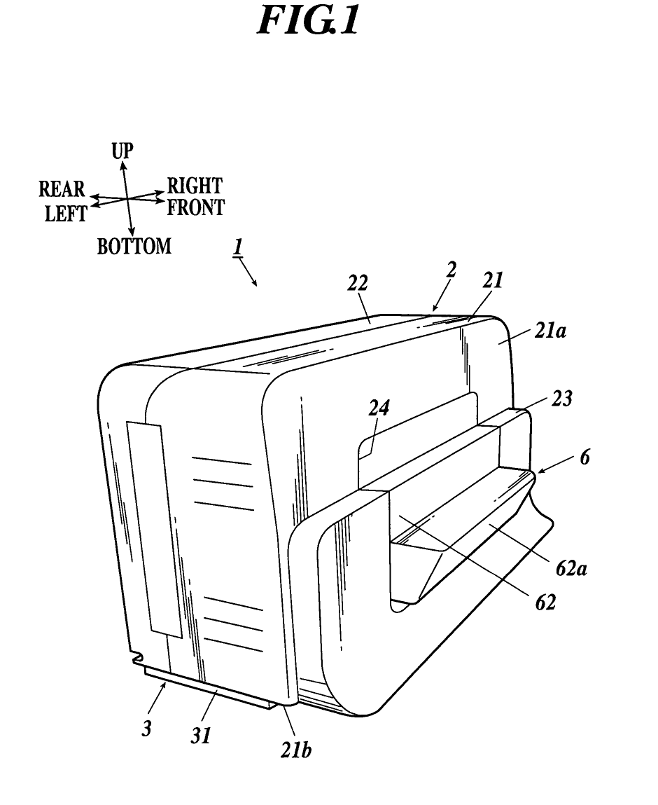

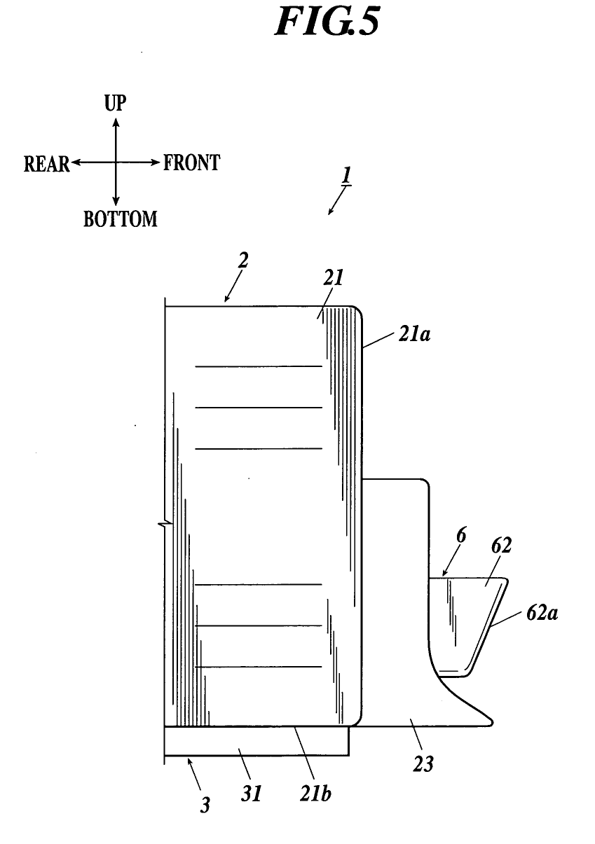

First, as shown in FIGS. 1 to 10 for example, the height direction-of the charging apparatus 1 is defined as the vertical direction, the widthwise direction of the charging apparatus 1 is defined as the lateral direction, and a depth direction of the charging apparatus 1 is defined as the front-rear direction.

As shown in FIGS. 1 to 10 for example, the charging apparatus 1 includes a main body 2, an adjusting section 3 which adjust the height position of the main body 2, and a convex contact terminal 4 as a contact terminal which comes into contact with a concave contact terminal 81 as a terminal provided in the self-propelled cleaner 8 when the self-propelled cleaner 8 is engaged. The self-propelled cleaner 8 is detachably attached to the convex contact terminal 4. The charging apparatus 1 also includes a terminal moving and turning mechanism 5 which moves the convex contact terminal 4 in the front-rear direction in association with the engaging motion and the disengaging motion of the self-propelled cleaner 8 with and from the convex contact terminal 4. The terminal moving and turning mechanism 5 vertically turns convex contact terminal 4 such as to follow the shapes of contact surfaces 41a and 42a with respect to the concave contact terminal 81 of the self-propelled cleaner 8. The charging apparatus 1 also includes a cover 6 which exposes the convex contact terminal 4 and the terminal moving and turning mechanism 5 by a force from the self-propelled cleaner 8 in association with the engaging motion of the self-propelled cleaner 8 with the convex contact terminal 4, and which covers the convex contact terminal 4 and the terminal moving and turning mechanism 5 by the gravity based on the weight of the cover 6 itself in association with the disengaging motion of the self-propelled cleaner 8 from the convex contact terminal 4.

As shown in FIGS. 1 to 9 for example, the outer shape of the main body 2 is of a substantially rectangular parallelepiped, and the main body 2 includes a combination of a front surface case body 21 and a rear surface case body 22 which are divided in the vertical direction at a position rearward of the center in the front-rear direction. The front surface case body 21 is provided at its front surface 21a with a projection 23 formed by projecting a substantially lower half of the front surface 21a forward.

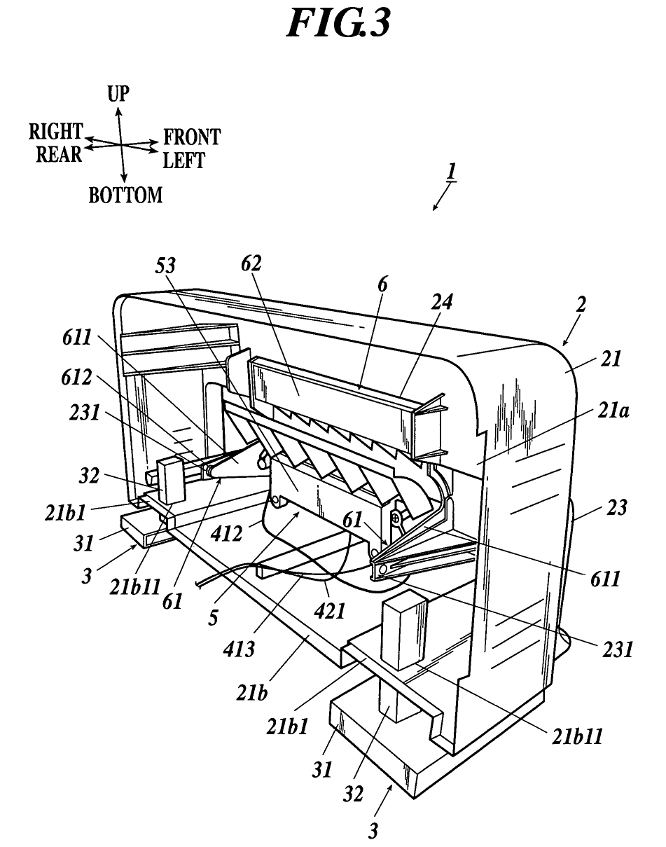

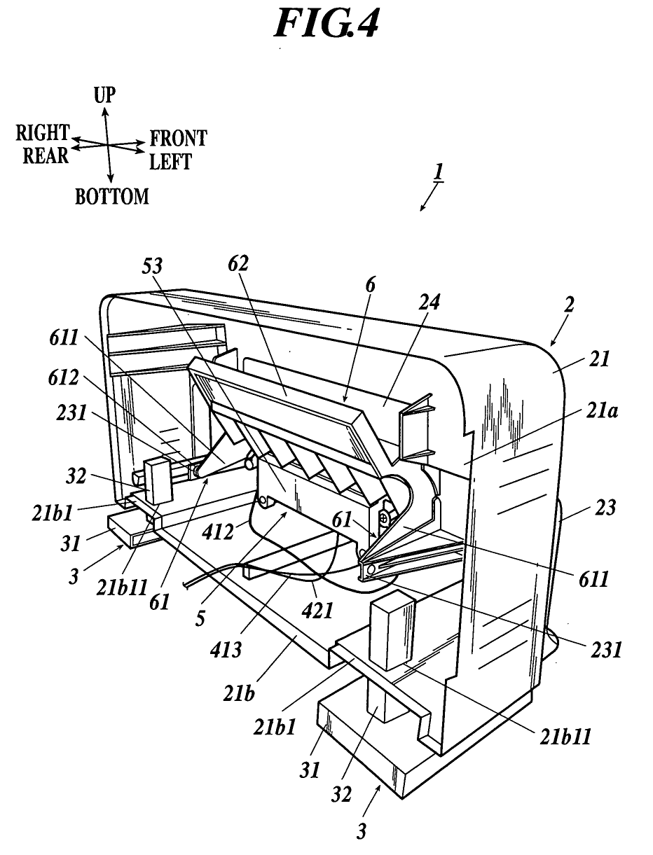

As shown in FIGS. 3 and 4, left and right sides of a lower surface 21b of the front surface case body 21 are provided with recesses 21b1 and 21b1 formed by recessing the lower surface 21b upward.

The recess 21b1 is provided at its bottom surface with a through hole 21b11 which vertically penetrates the bottom surface.

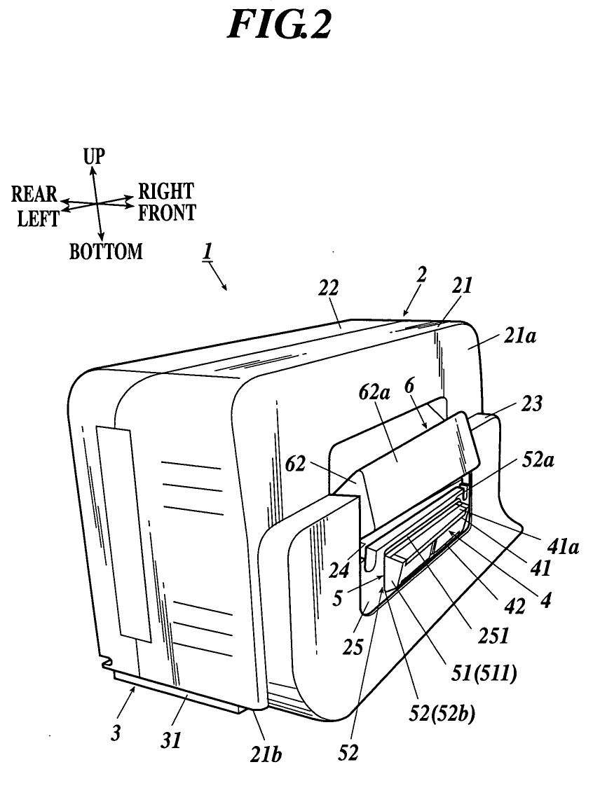

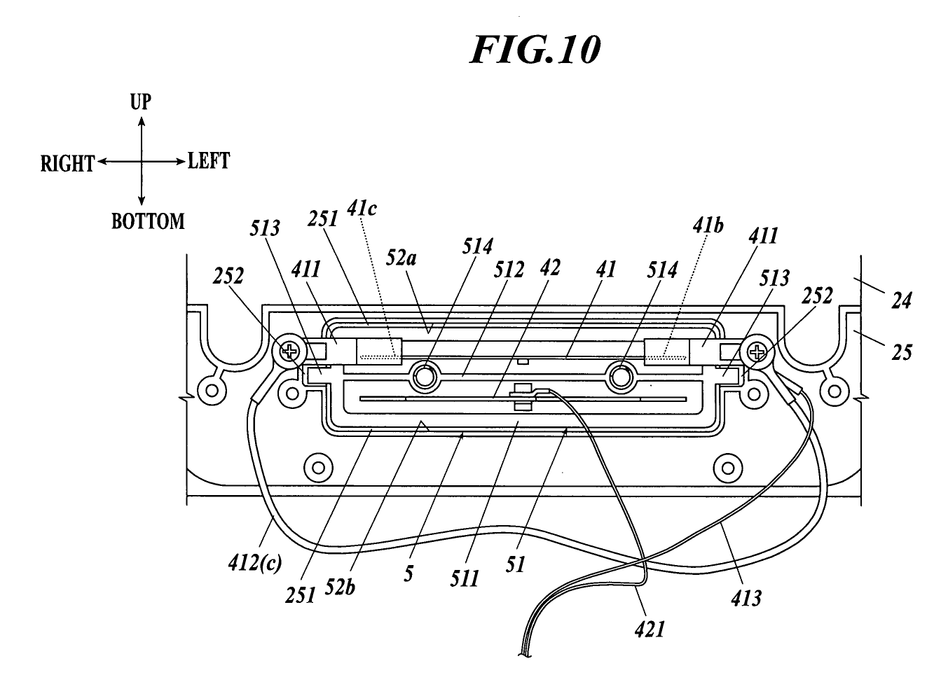

As shown in FIGS. 1 to 4, an opening 24 is formed in a central portion of the front surface 21a of the front surface case body 21 beyond the projection 23. The opening 24 is formed into a substantially rectangular shape which is long in the lateral direction. As shown in FIG. 2, the opening 24 is provided at its lower side with a mounting section 25 having an opening portion 251. The opening portion 251 is of a substantially rectangular shape which is long in the lateral direction. As shown in FIG. 10, the mounting section 25 is provided at its back surface with grooves 252 and 252 which are adjacent to the opposite ends of the opening portion 251 in the front-rear direction. Terminal moving and turning shafts 513 and 513 provided on the terminal moving and turning section 51 of the terminal moving and turning mechanism 5 are accommodated in the grooves 252 and 252 rotatably and movably in the front-rear direction.

As shown in FIGS. 3 and 4, support portions 231 and 231 are provided on an inner surface of the projection 23 of the front surface case body 21 on laterally outer sides than the opening 24. The support portions 231 and 231 rotatably supports cover turning shafts 612 and 612 provided on the cover turning portions 61 and 61 of the cover 6.

As shown in FIGS. 3 and 4, the adjusting section 3 includes leg plates 31 disposed below the recesses 21b1 provided in the lower surface 21b of the front surface case body 21. The adjusting section 3 also includes a adjusting main bodies 32 which are fixed to an upper surface of the leg plates 31, which are inserted through the through holes 21b11 of the recess 21b1, and which can vertically move if a force greater than a force for supporting the main bodies 2 is applied.

More specifically, if the adjusting main body 32 is vertically moved by the adjusting section 3, the main body 2 is vertically moved, and the height position of the charging apparatus 1 can be adjusted.

As shown in FIGS. 2 and 6 to 10, the convex contact terminal 4 includes a plus electrode terminal 41 as a plus convex contact terminal formed long in the lateral direction of the main body 2 of the charging apparatus 1, and a minus electrode terminal 42 as a minus convex contact terminal.

As shown in FIGS. 2 to 4 and 6 to 10, the terminal moving and turning mechanism 5 includes a terminal moving and turning section 51 as a moving member on which the convex contact terminal 4 is mounted and which is supported on the mounting section 25 of the front surface case body 21 of the main body 2 such that the terminal moving and turning section 51 can move in the front-rear direction, and which is supported vertically rotatably, a restriction portion 52 which restricts a vertical turning amount of the terminal moving and turning section 51 and the convex contact terminal 4, and a protection plate 53 which covers the terminal moving and turning section 51 and the restriction portion 52 from behind.

As shown in FIGS. 2 and 6 to 10 for example, the terminal moving and turning section 51 includes a terminal moving and turning main body 511 which has a substantially U-shaped cross section in the vertical direction perpendicular to the lateral direction, and which is long in the lateral direction, a reinforcing member 512 which is fixed along the lateral direction in the vicinity of a vertically central portion of an inner surface of the terminal moving and turning main body 511, terminal moving and turning shafts 513 and 513 which are fixed such as to project outward in the vicinity of the vertically central portion of both ends in the front-rear direction of the terminal moving and turning main body 511, and resilient members 514 and 514 as biasing members for biasing the terminal moving and turning section 51 forward. The resilient members 514 and 514 are fixed such that they can resiliently deform in the front-rear direction in the vicinity of the vertically central portion on left and right sides of the inner surface of the terminal moving and turning main body 511.

The length of the terminal moving and turning main body 511 in the front-rear direction is shorter than the length of the opening portion 251 in the front-rear direction provided in the mounting section 25 of the front surface case body 21, and is longer than the length of the convex contact terminal 4 in the front-rear direction. The length of the terminal moving and turning main body 511 in the short direction is shorter than the length of the opening portion 251 in the short direction.

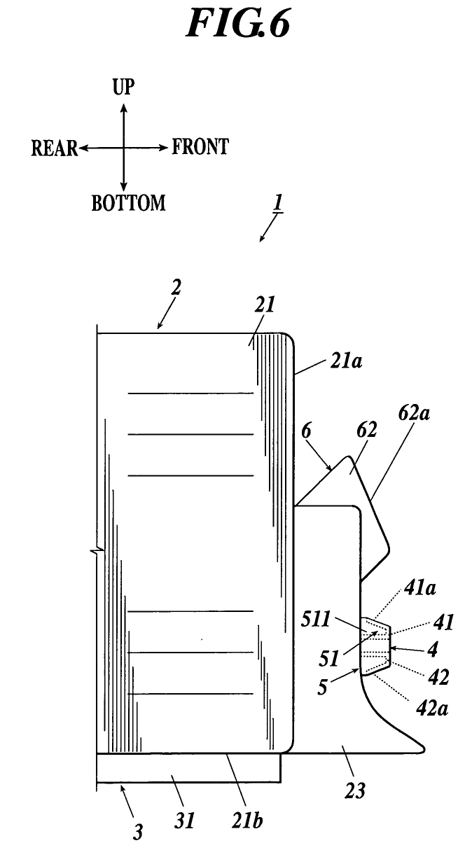

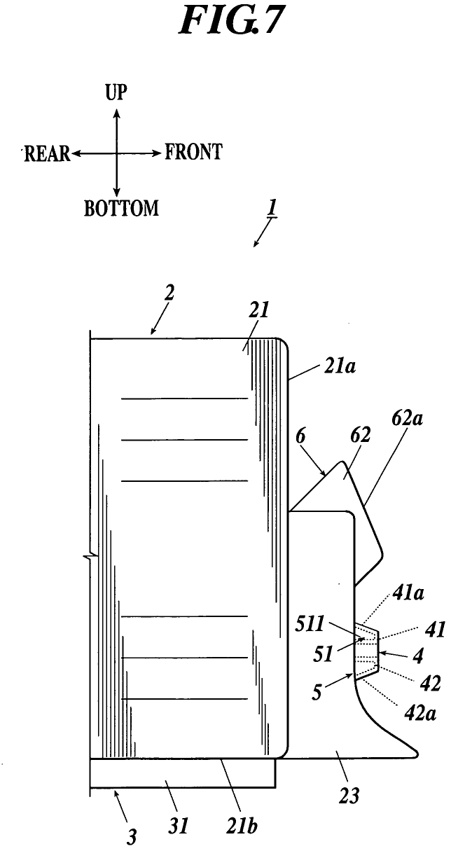

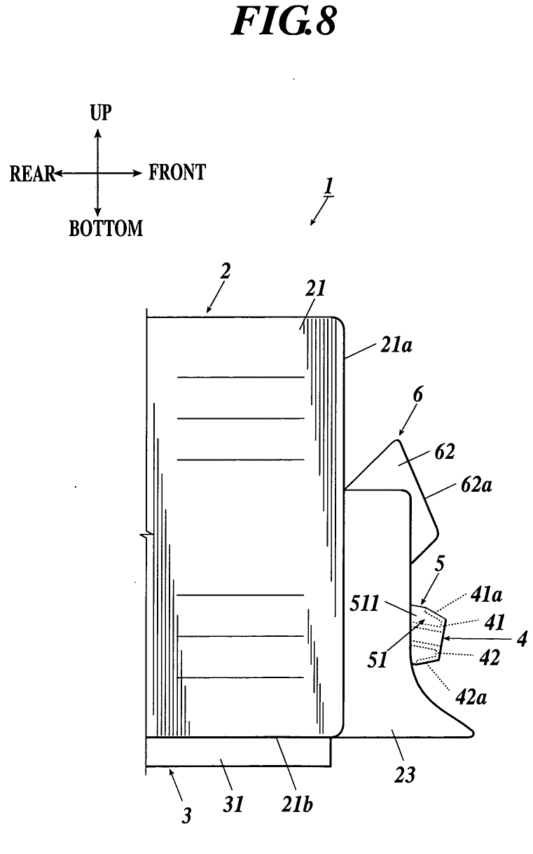

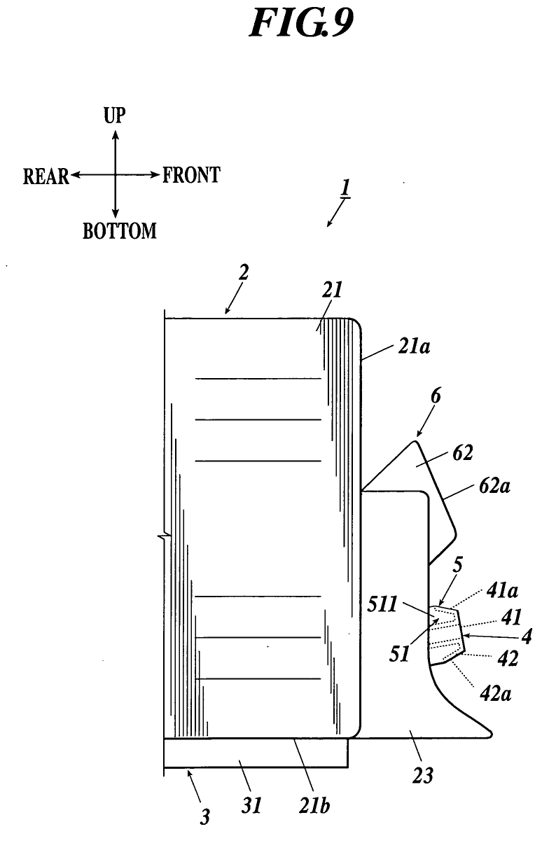

The terminal moving and turning section 51 projects forward from the main body 2 by passing through the terminal moving and turning main body 511 forward from behind the opening portion 251. If the main body 2 is provided with the terminal moving and turning section 51, the terminal moving and turning shafts 513 and 513 are accommodated in the grooves 252 and 252 formed in the both ends of the opening portion 251 in the front-rear direction, the terminal moving and turning section 51 is longitudinally movably supported by the main body 2 by the terminal moving and turning shafts 513 and 513 accommodated in the grooves 252 and 252 as shown in FIGS. 6 and 7, and is supported by the main body 2 with being vertically rotatable as shown in FIGS. 8 and 9.

As shown in FIGS. 2 and 6 to 10, a plus electrode terminal 41 of the convex contact terminal 4 is disposed in the terminal moving and turning section 51 above the terminal moving and turning main body 511, and a minus electrode terminal 42 of the convex contact terminal 4 is disposed below the terminal moving and turning main body 511. The plus electrode terminal 41 and the minus electrode terminal 42 are mounted on and connected to the terminal moving and turning section 51 such that portions of the plus electrode terminal 41 and the minus electrode terminal 42 are exposed to a front surface of the terminal moving and turning main body 511.

As shown in FIG. 10, on an inner surface of the terminal moving and turning main body 511, the plus electrode terminal 41 is located between an upper surface of the terminal moving and turning main body 511 and the reinforcing member 512, and the minus electrode terminal 42 is located between a lower surface of the terminal moving and turning main body 511 and the reinforcing member 512 for example.

Two electrode plates 411 and 411 as electrodes are fixed to a rear surface of the mounting section 25 at a location where the electrode plates 411 and 411 can be connected to the left end 41b and the right end 41c as connections in the rear end of the plus electrode terminal 41. A first lead wire 412 for connecting one of the electrode plates 411 and 411 and the other electrode plate 411 with-each other, and a second lead wire 413 for connecting the one electrode plate 411 and an electricity producing circuit or a power supply (not shown) are mounted on the electrode plates 411 and 411.

A third lead wire 421 connected to an electricity producing circuit and a power supply (not shown) is mounted on a portion of an inner surface of the terminal moving and turning main body 511 in the vicinity of a central portion of the minus electrode terminal 42 in its lateral direction.

Here, a current-carrying member for carrying electricity to the self-propelled cleaner 8 through the convex contact terminal 4 includes the electrode plates 411 and 411, the first lead wire 412, the second lead wire 413, the third lead wire 421, and the electricity producing circuit and the power supply.

Free ends of the resilient members 514 and 514 fixed to the left and right sides of the inner surface of the terminal moving and turning main body 511 are in contact with a front surface of the protection plate 53 for example, and bias the terminal moving and turning section 51 forward.

More specifically, while the self-propelled cleaner 8 is disengaged, the terminal moving and turning section 51 and the convex contact terminal 4 are moved forward by the forward biasing force of the resilient member 514, and both the left end 41b and right end 41c of the rear end of the plus electrode terminal 41 are disengaged from the electrode plate 411.

The terminal moving and turning section 51 and the convex contact terminal 4 are moved rearward by the force of the self-propelled cleaner 8 in association with the engaging motion of the self-propelled cleaner 8 with respect to the convex contact terminal 4, at least one of the left end 41b and the right end 41c of the rear end of the plus electrode terminal 41 is electrically connected to the electrode plate 411, the convex contact terminal 4 can reliably come into contact with the concave contact terminal 81 of the self-propelled cleaner 8 by the forward biasing force of the resilient member 514. If at least one of the left end 41b and the right end 41c of the rear end of the plus electrode terminal 41 is electrically connected to the electrode plate 411, the plus electrode terminal 41 is electrically connected to the second lead wire 413 through the first lead wire 412. Since the minus electrode terminal 42 is always in electrical contact with the third lead wire 421, if the self-propelled cleaner 8 is engaged, the charging apparatus 1 is turned ON, the charging apparatus 1 supplies electricity to the self-propelled cleaner 8 through the convex contact terminal 4 and the concave contact terminal 81 which is in contact with the convex contact terminal 4, and the charging apparatus 1 supplies electricity to the self-propelled cleaner 8.

As shown in FIGS. 2 and 10, the restriction portion 52 corresponds to an upper edge 52a and a lower edge 52b of the opening portion 251 formed in the mounting section 25 of the front surface case body 21.

More specifically, when the terminal moving and turning section 51 on which the convex contact terminal 4 is mounted is downwardly turned, a lower surface of the terminal moving and turning main body 511 collides against the restriction portion 52 corresponding to the lower edge 52b of the opening portion 251, and the downward turning amounts of the terminal moving and turning section 51 and the convex contact terminal 4 are restricted.

When the terminal moving and turning section 51 on which the convex contact terminal 4 is mounted is upwardly turned, an upper surface of the terminal moving and turning main body 511 collides against the restriction portion 52 corresponding to the upper edge 52a of the opening portion 251, and the upward turning amounts of the terminal moving and turning section 51 and the convex contact terminal 4 are restricted.

Therefore, the upward and downward turning amounts of the terminal moving and turning section 51 and the convex contact terminal 4 can be adjusted by the ratio of the length of the opening portion 251 in the short direction and the length of the terminal moving and turning section 51 (terminal moving and turning main body 511) in the short direction.

In this embodiment, the upward turning amount and the downward turning amount are set to 5°.

As shown in FIGS. 1 to 9, the cover 6 is disposed in the vicinity of a center of a front side of the main body 2. The cover 6 includes the cover turning portion 61 which is vertically rotatably supported by the support portions 231 and 231 provided on the inner surface of the projection 23 of the front surface case body 21, and a cover main body 62 which is connected to the cover turning portion 61 and which covers the convex contact terminal 4 and the terminal moving and turning mechanism 5 from front.

As shown in FIGS. 3 and 4, the cover turning portion 61 includes a pair of left and right turning pieces 611 and 611 rearwardly projecting from both ends of the cover main body 62 in the lateral direction, and cover turning shafts 612 and 612 which is rotatably supported by the support portions 231 and 231 of the front surface case body 21. The cover turning portion 61 is vertically rotatably supported on the main body 2 by the cover turning shafts 612 and 612 pivotally supported by the support portions 231 and 231.

As shown in FIG. 1, the cover main body 62 is formed into a two-step shape in which a parallel surface which is substantially in parallel to the front surface 21a of the front surface case body 21, and a vertical surface which is substantially vertical with respect to the parallel surface are alternately continuously formed from its upper portion in a state where the cover 6 covers the convex contact terminal 4 and the terminal moving and turning mechanism 5 from front. The cover main body 62 also includes an inclined surface 62a which is continuously formed on the second vertical surface from the upper portion and which is upwardly inclined toward the outer side (front side) of the charging apparatus 1. The lower surface of the cover main body 62 is an opening surface.

<Engaging Motion and Disengaging Motion of Self-Propelled Cleaner with Respect to Charging Apparatus>

If the electricity amount accumulated in the storage battery (not shown) of the self-propelled cleaner 8 becomes equal to or smaller than a threshold value, the self-propelled cleaner 8 autonomously moves in a substantially horizontal direction toward the charging apparatus 1 for putting the storage battery (not shown) on charge.

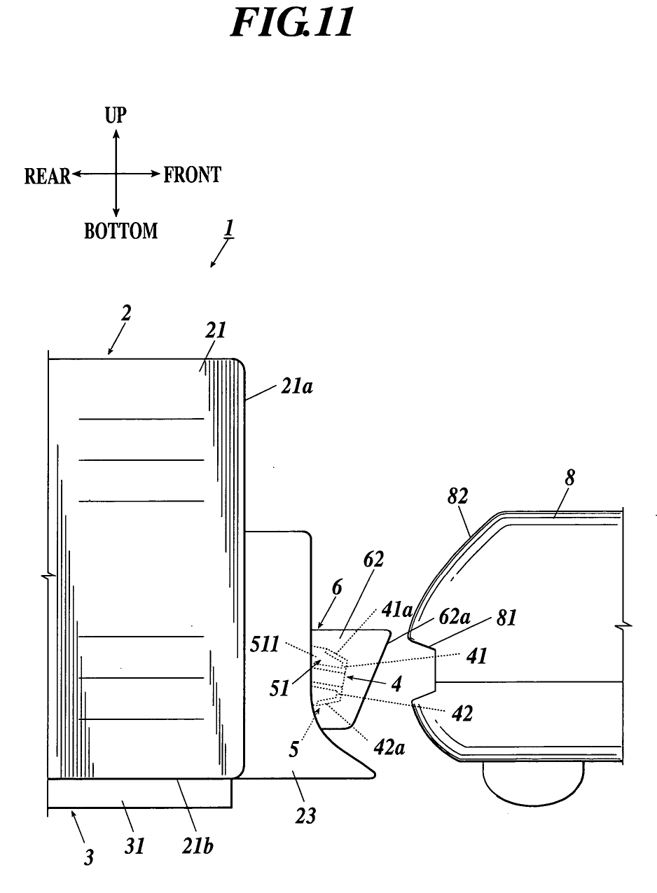

First, in a state where the self-propelled cleaner 8 is disengaged from the charging apparatus 1, as shown in FIG. 11 for example, the cover turning portion 61 of the cover 6 of the charging apparatus 1 is in a state where the cover turning portion 61 is downwardly turned by the gravity based on the weight of the cover 6, and the cover main body 62 of the cover 6 covers the convex contact terminal 4. The terminal moving and turning section 51 of the terminal moving and turning mechanism 5 of the charging apparatus 1 is in a state where the terminal moving and turning section 51 is downwardly turned by the gravity based on the weight of the terminal moving and turning section 51, and the downward turning amount of the terminal moving and turning section 51 is restricted by the restriction portion 52 of the terminal moving and turning mechanism 5 corresponding to the lower edge 52b of the opening portion 251. In this state, since the terminal moving and turning section 51 of the terminal moving and turning mechanism 5 is biased by the resilient members 514 and 514 and is moved forward, any of the left end 41b and right end 41c of the rear end of the plus electrode terminal 41 of the convex contact terminal 4 is not connected to the electrode plate 411, and the power supply of the charging apparatus 1 is OFF.

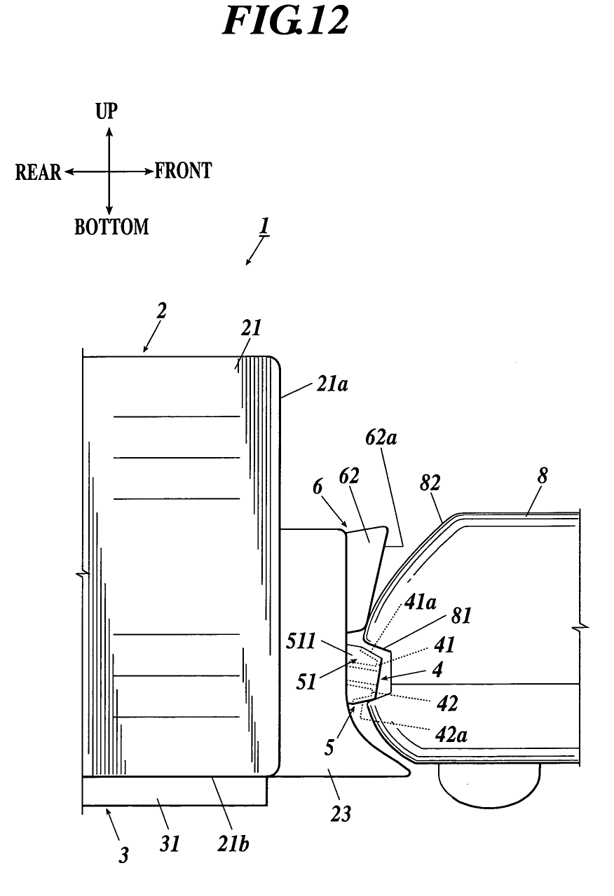

At the time of the engaging motion of the self-propelled cleaner 8 with respect to the convex contact terminal 4, as shown in FIG. 12 for example, the cover main body 62 of the cover 6 of the charging apparatus 1 comes into contact with a side surface 82 of the self-propelled cleaner 8 in the inclined surface 62a, a force from the self-propelled cleaner 8 is transmitted to the cover turning portion 61 of the cover 6, and the cover turning portion 61 is turned upward (i.e., in the direction in which the cover main body 62 exposes the convex contact terminal 4) by a force from the self-propelled cleaner 8 transmitted by the cover main body 62. The terminal moving and turning section 51 of the terminal moving and turning mechanism 5 of the charging apparatus 1 turns upward such as to follow the shape of the contact surfaces 41a and 42a between the concave contact terminal 81 of the self-propelled cleaner 8 in the convex contact terminal 4, thereby turning the convex contact terminal 4 upward.

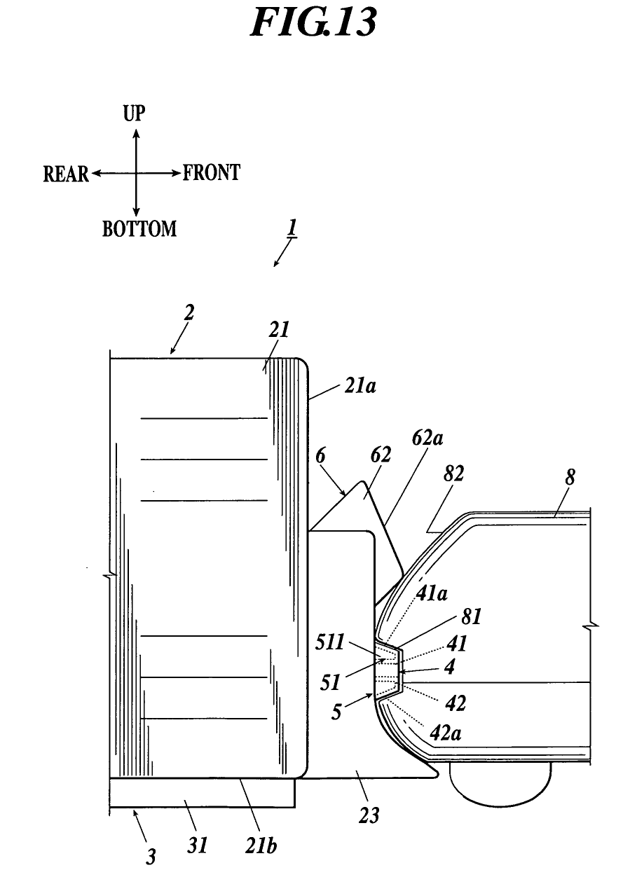

When the self-propelled cleaner 8 is engaged with the convex contact terminal 4, as shown in FIG. 13 for example, the convex contact terminal 4 of the charging apparatus 1 is reliably in contact with the concave contact terminal 81 of the self-propelled cleaner 8 by a rearward force from the self-propelled cleaner 8 and a forward biasing force of the resilient member 514. In this state, since the terminal moving and turning section 51 and the convex contact terminal 4 rearwardly move by the force from the self-propelled cleaner 8 and the moving amount is sufficient, at least one of the left end 41b and right end 41c of the rear end of the plus electrode terminal 41 is in electrical contact with the electrode plate 411. That is, in this state, the power supply of the charging apparatus 1 is ON, electricity is supplied to the self-propelled cleaner 8 through the convex contact terminal 4 and the concave contact terminal 81 which is in contact with the convex contact terminal 4, and electricity for charging the storage battery (not shown) of the self-propelled cleaner 8 can be supplied.

If the charging operation of the storage battery (not shown) is completed, the self-propelled cleaner 8 runs autonomously and is disengaged from the charging apparatus 1.

In the disengaging motion of the self-propelled cleaner 8 with respect to the convex contact terminal 4, as shown in FIG. 12 for example, the cover turning portion 61 of the cover 6 of the charging apparatus 1 is turned downward (i.e., in a direction in which the cover main body 62 covers the convex contact terminal 4) by the gravity based on the weight of the cover 6. The terminal moving and turning section 51 of the terminal moving and turning mechanism 5 of the charging apparatus 1 is turned downward such as to follow the shape of the contact surfaces 41a and 42a of the concave contact terminal 81 of the self-propelled cleaner 8 of the convex contact terminal 4, thereby turning the convex contact terminal 4 downward. In this state, the terminal moving and turning section 51 of the terminal moving and turning mechanism 5 is gradually released from the rearward force from the self-propelled cleaner 8, and the terminal moving and turning section 51 is gradually moved forward by the biasing force from the resilient member 514. Therefore, any of the left end 41b and right end 41c of the rear end of the plus electrode terminal 41 of the convex contact terminal 4 is not connected to the electrode plate 411, and the power supply of the charging apparatus 1 is OFF.

Thereafter, the self-propelled cleaner 8 is disengaged from the charging apparatus 1 as shown in FIG. 11.

According to the above-explained charging apparatus 1 of the invention, the self-propelled cleaner 8 which runs autonomously for the charging operation can be engaged with and disengaged from the charging apparatus 1, the charging apparatus includes the convex contact terminal 4 which comes into contact with the concave contact terminal 81 provided in the self-propelled cleaner 8 when the self-propelled cleaner 8 is engaged, and which supplies electricity to the self-propelled cleaner 8, the terminal moving and turning section 51 on which the convex contact terminal 4 is mounted and which is supported by a main body 2 of the charging apparatus 1 such that the terminal moving and turning section 51 can move in the front-rear direction and turn in the vertical direction, resilient members 514 and 514 which bias the terminal moving and turning section 51 forward, and a current-carrying member which supplies electricity to the self-propelled cleaner 8 through the convex contact terminal 4. The convex contact terminal 4 is formed long in the lateral direction of the main body 2 of the charging apparatus 1. The minus electrode terminal 42 of the convex contact terminal 4 is always in contact with the current-carrying member (such as third lead wire 421), and the current-carrying member (electrode plates 411 and 411) are located at a position where the current-carrying member can electrically connected to the left end 41b and right end 41c of the rear end of the plus electrode terminal 41. The plus electrode terminal 41 of the convex contact terminal 4 is separated from the current-carrying member (electrode plates 411 and 411) when the terminal moving and turning section 51 is moved forward by the resilient members 514 and 514, and if the terminal moving and turning section 51 is moved rearward by a force from the self-propelled cleaner 8 in association with an engaging motion of the self-propelled cleaner 8 with respect to the convex contact terminal 4, at least of the left end 41b and right end 41c of the rear end of the plus electrode terminal 41 can be electrically connected with the current-carrying member (such as electrode plate 411).

That is, the convex contact terminal 4 is long in the lateral direction, and the terminal moving and turning section 51 moves rearward by the force from the self-propelled cleaner 8 in association with the engaging motion of the self-propelled cleaner 8. With this, if at least one of the left end 41b and right end 41c of the rear end of the plus electrode terminal 41 of the convex contact terminal 4 comes into contact with the current-carrying member (such as electrode plate 411), electricity can be supplied to the self-propelled cleaner 8 by the current-carrying member through the convex contact terminal 4. That is, a force from the self-propelled cleaner 8 can be received with “lines”. Even if all of the “lines” (all of the rear end of the plus electrode terminal 41) can not be connected to the current-carrying member due to an error in the lateral direction of fine errors in the engaging position and engaging angle of the self-propelled cleaner 8, if at least one end (at least one end of the left end 41b and right end 41c of the rear end of the plus electrode terminal 41) of the “lines” is connected to the current-carrying member, electricity can be supplied to the self-propelled cleaner 8. Therefore, with a simple structure, only when the self-propelled cleaner 8 is reliably and efficiently engaged, electricity can be supplied.

The terminal moving and turning section 51 is supported by the main body 2 of the charging apparatus 1 such that the terminal moving and turning section 51 can turn in the vertical direction. Therefore, of the fine errors in the engaging position and engaging angle of the self-propelled cleaner 8, it is possible to accept not only an error in the lateral direction but also an error in the vertical direction, and electricity can be supplied more reliably and more efficiently only when the self-propelled cleaner 8 is engaged.

The present invention is not limited to the above embodiment, and the invention can appropriately be modified within a range not departing from its subject matter.

The two ends, i.e., the left end 41b and right end 41c of the rear end of the plus electrode terminal 41 of the convex contact terminal 4 are the connection portions which are connected to the current-carrying member (such as the electrode plate 411), but the number of connection portions are not limited only if the number is two or more. The position of the connection portion of the plus electrode terminal 41 is not limited only if it can be connected to the current-carrying member (such as the electrode plate 411).

The minus electrode terminal 42 of the convex contact terminal 4 is always connected to the current-carrying member (such as the third lead wire 421), and the plus electrode terminal 41 is connected to the current-carrying member (such as the electrode plate 411) if the self-propelled cleaner 8 is engaged, but the terminals may be reversed. That is, the plus electrode terminal may be always connected to the current-carrying member and the minus electrode terminal may be connected to the current-carrying member when the self-propelled cleaner 8 is engaged.

If the contact terminal (convex contact terminal 4 in the embodiment) provided in the charging apparatus 1 and the terminal (concave contact terminal 81 in the embodiment) provided in the self-propelled cleaner 8 can be contacted with each other, their shapes are not limited.

The apparatus to be charged which can be charged by the charging apparatus 1 is not limited to the self-propelled cleaner 8. The apparatus to be charged can be engaged with and disengaged from the charging apparatus 1 automatically or manually.

If the adjusting section 3 can adjust the height position of the charging apparatus 1, its structure is not limited.

The entire disclosure of Japanese Patent Application No. 2005-375558 filed on Dec. 27, 2005, including description, claims, drawings and summary are incorporated herein by reference.

What is claimed is:

1. A charging apparatus for a self-propelled apparatus which supplies electricity for electric charging to the self-propelled apparatus performing autonomous run for the electric charging, the charging apparatus comprising:
a convex contact terminal which comes into contact with a concave contact terminal provided to the self-propelled apparatus to supply electricity to the self-propelled apparatus, when the self-propelled apparatus is detachably attached;
a moving member on which the convex contact terminal is mounted and which is supported by a main body of the charging apparatus movably in a front-rear direction and rotatably in a vertical direction;
a biasing member to bias the moving member forward; and
a current-carrying member to supply electricity to the self-propelled apparatus through the convex contact terminal,
wherein the convex contact terminal is long in a lateral direction of the main body of the charging apparatus,
a minus convex contact terminal of the convex contact terminal is constantly in electrical contact with the current-carrying member, a plus convex contact terminal separates from the current-carrying member when the moving member moves forward by the biasing member, and at least one of a left end and a right end of the plus convex contact terminal is electrically connected to the current-carrying member when the moving member moves rearward by a force from the self-propelled apparatus in association with an engaging motion of the self-propelled apparatus with the convex contact terminal, and
the current-carrying member includes two electrodes which are electrically connected to the left end and the right end of the plus convex contact terminal respectively.

2. A charging apparatus which supplies electricity to an apparatus to be charged, comprising:
a contact terminal which comes into contact with a terminal provided on the apparatus to be charged to supply electricity to the apparatus to be charged, when the apparatus to be charged is detachably attached;
a moving member on which the contact terminal is mounted and which is supported by a main body of the charging apparatus movably in a front-rear direction;
a biasing member to bias the moving member forward; and
a current-carrying member to supply electricity to the apparatus to be charged through the contact terminal,
wherein one of a minus terminal and a plus terminal of the contact terminal is constantly in electrical contact with the current-carrying member, the other of the contact terminal separates from the current-carrying member when the moving member moves forward by the biasing member, and at least one of a plurality of connecting parts of the other of the contact terminal is electrically connected to the current-carrying member when the moving member moves rearward by a force from the apparatus to be charged in association with an engaging motion of the apparatus to be charged with the contact terminal.

3. The charging apparatus as claimed in claim 2, wherein the contact terminal is long in a lateral direction of the main body of the charging apparatus, and the current-carrying member includes two electrodes which are electrically connected to the left end and the right end of the other of the contact terminal respectively.

4. The charging apparatus as claimed in claim 2, wherein the moving member is supported by the main body of the charging apparatus rotatably in a vertical direction.

5. The charging apparatus as claimed in claim 1, wherein the self-propelled apparatus is a self-propelled cleaner.
